(19) United States
(12) Patent Application Publication
(10) Pub. No.: US 2024/0184074 A1
(43) Pub. Date: Jun. 6, 2024

(54) OPTICAL MODULE INCLUDING RIBBONIZED FIBERS AND A FIBER ROUTING DEVICE

(71) Applicant: Lumentum Operations LLC, San Jose, CA (US)

(72) Inventors: Luqing WU, Shenzhen (CN); Bin TAN, Shenzhen (CN); Wanying CHEN, Shenzhen (CN)

(21) Appl. No.: 17/796,823

(22) PCT Filed: Mar. 31, 2022
(86) PCT No.: PCT/CN2022/084474

§ 371 Date: Aug. 1, 2022

(30) Foreign Application Priority Data
Aug. 18, 2021 (WO) PCTCN2021113281

(51) Int. Cl. G02B 6/44; G02B 6/36

(52) U.S. Cl. CPC G02B 6/4454; G02B 6/3608

(57) ABSTRACT

A fiber routing device may include a planar structure. The fiber routing device may include a set of fiber features associated with organizing fibers for forming ribbon groups, the set of fiber features being held by the planar structure. A first end of a fiber feature of the set of fiber features may be at a first side of the fiber routing device. A second end of the fiber feature may be at a second side of the fiber routing device or may be between the first side of the fiber routing device and the second side of the fiber routing device.

### CROSS-REFERENCE TO RELATED APPLICATION

This patent application claims priority to Patent Cooperation Treaty (PCT) Patent Application No. PCT/CN2021/113281, filed on Aug. 18, 2021, and entitled “RIBBONIZED OPTICAL MODULE INCLUDING A FIBER ROUTING DEVICE.” The disclosure of the prior application is considered part of and is incorporated by reference into this patent application.

### TECHNICAL FIELD

The present disclosure relates generally to an optical module and to an optical module including a fiber routing device that allows a number of ribbonized groups of fibers to be increased, which increases ribbon splice opportunities, increases flexibility in a number of fibers per ribbon splice and per ribbon, and reduces a number of splices of individual fibers.

### BACKGROUND

An optical module may include a group of passive components among which fibers need to be routed. An assembly process for the optical module may include placement of a given passive component, initial fiber routing (to determine a required fiber length) associated with the passive component, a series of fiber management processes (e.g., cutting, stripping, cleaning, splicing, and coating) associated with the passive component, and final fiber routing associated with the passive component. Generally, this series of steps need to be performed for each passive component of the optical module.

### SUMMARY

In some implementations, a fiber routing device may include a planar structure; and a set of fiber features associated with organizing fibers for forming ribbon groups, the set of fiber features being held by the planar structure, wherein a first end of a fiber feature of the set of fiber features is at a first side of the fiber routing device, and a second end of the fiber feature is one of: at a second side of the fiber routing device, or between the first side of the fiber routing device and the second side of the fiber routing device.

In some implementations, a device includes a first set of loose fibers; a set of passive components having a second set of loose fibers; and a fiber routing device having a third set of loose fibers, wherein the fiber routing device and the set of passive components are collocated such that the first set of loose fibers, the second set of loose fibers, and the third set of loose fibers are collocated or aligned in opposite directions.

In some implementations, an optical card includes an optical module including a fiber routing device including a plurality of fiber features associated with organizing fibers for forming ribbon groups, wherein a first fiber feature of the plurality of fiber features is a first type of fiber feature and a second fiber feature of the plurality of fiber features is a second type of fiber feature that is different from the first type of fiber feature.

### BRIEF DESCRIPTION OF THE DRAWINGS

FIGS. 1A and 1B are diagrams of an example device including a fiber routing device described herein.

FIGS. 2A and 2B are diagrams illustrating examples of fiber routing devices including various fiber features, as described herein.

FIG. 3 is a diagram of an example illustrating an example fiber routing device including a set of tube components, as described herein.

### DETAILED DESCRIPTION

The following detailed description of example implementations refers to the accompanying drawings. The same reference numbers in different drawings may identify the same or similar elements.

Passive component assembly is a time-consuming step of an optical module assembly process. For example, over 50% of assembly time may be used to handle passive component assembly. With the complex fiber interconnections of many individual fibers and crossovers to arrange fibers appropriately for interconnection, a manufacturing process needs a special fiber routing design to accommodate a fiber direction inversion requirement, typically by using figure-eight paths for individual fibers within fiber trays. However, the fibers need to be handled one by one and spliced one by one in this process, which is inefficient, heavily manual, and difficult or impossible to automate.

Some aspects described herein provide a fiber routing device (sometimes referred to as a fiber routing plane (FRP)), an optical module including the fiber routing device, and an assembly process for the optical module. In some implementations, the optical module may be, for example, an optical amplifier, a wavelength selective switch (WSS), an optical circuit pack, or an optical blade, among other examples. In some implementations, the fiber routing device allows a number of ribbonized groups of fibers (herein referred to as ribbons) in the optical module to be increased. An increased number of ribbons increases ribbon splice opportunities, increases flexibility in a number of fibers per ribbon splice and ribbon, and reduces a number of splices of individual fibers. The use of ribbon splices to connect ribbons within the optical module simplifies assembly of the optical module by reducing a number of required splices. Further, when ribbonized, the fibers are protected sufficiently so that fiber trays may not be needed in the optical module, and constraints on where fiber may be routed within the optical module and/or a location of a printed circuit board (PCB)/PCB assembly (PBCA) are relaxed (e.g., as compared to constraints required when individual fibers are used). Additional details regarding the fiber routing device are provided below.

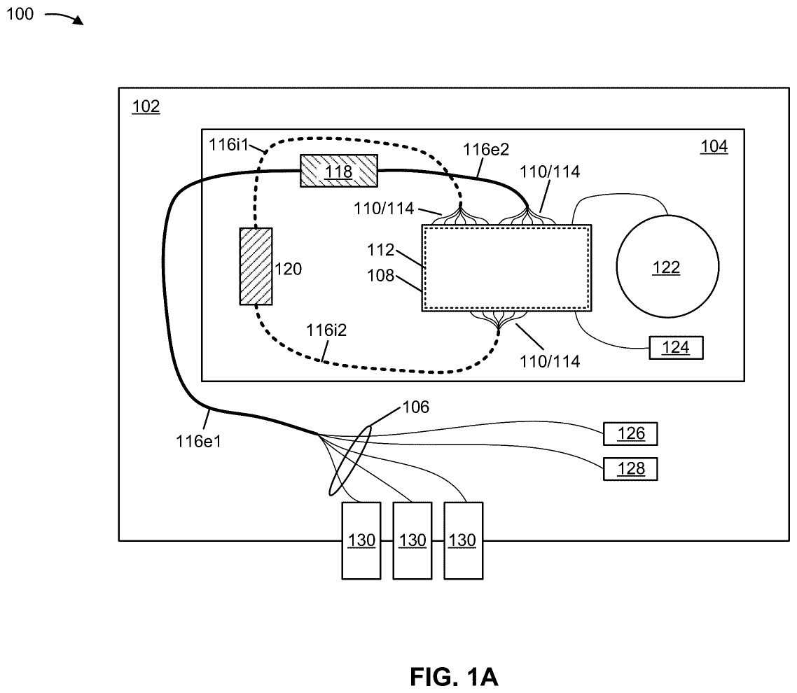

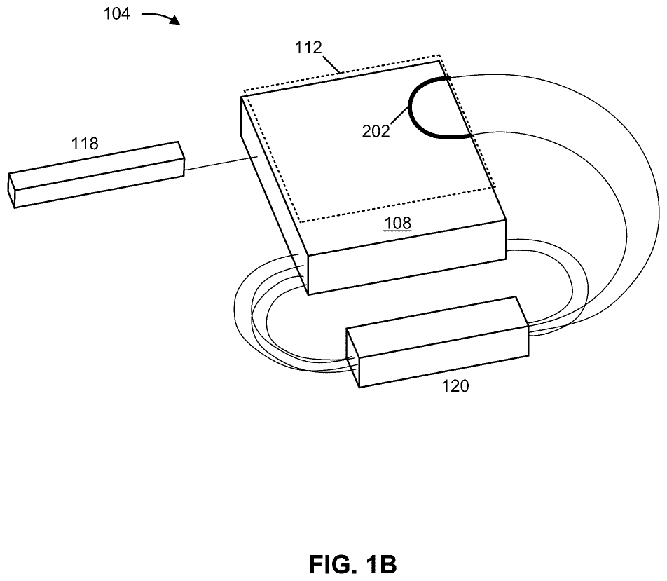

FIGS. 1A and 1B are diagrams associated with an example device 100 including a fiber routing device, as described herein. As shown in FIG. 1A, the device 100 includes an optical card 102 and an optical module 104. As shown, the device 100 may include a first set of loose fibers 106. The first set of loose fibers 106 is a set of fibers that connects optical components external to the optical module 104. Such external components may include, for example, one or more active components 126 (e.g., one or more photodiodes, one or more pumps, one or more variable optical amplifiers (VOAs), one or more switches, or the like), one or more passive components 128 (e.g., one or more erbium pigtails), or one or more connectors 130 (e.g., one or more faceplate connector pigtails), among other examples.

As further shown, the optical module 104 includes a set of passive components 108 having a second set of loose fibers 110. The second set of loose fibers 110 is a set of fibers (e.g., fiber pigtails) extending from one or more sides of the set of passive components 108 in one or more directions. For example, as shown in FIG. 1A, the second set of loose fibers 110 may include one or more fibers extending in an upward direction and may include one or more fibers extending in a downward direction. As further shown, the optical module 104 includes a fiber routing device 112 having a third set of loose fibers 114. The third set of loose fibers 114 is a set of loose fibers extending from fiber features of the fiber routing device 112 at one or more sides of the fiber routing device 112 in the one or more directions. For example, as shown in FIG. 1A, the third set of loose fibers 114 may include one or more fibers extending in the upward direction and may include one or more fibers extending in the downward direction. In the example shown in FIG. 1A, the second set of loose fibers 110 and the third set of loose fibers 114 are collocated and commonly aligned due to the arrangement of the fiber routing device 112 (e.g., to enable fibers among the second set of loose fibers 110 and the third set of loose fibers 114 can be ribbonized, as described below).

As shown, the device 100 includes ribbonized groups of fibers 116 (herein referred to as ribbons 116). For example, a ribbon 116e1 can be formed from the first set of loose fibers 106. That is, in some implementations, the first set of loose fibers 106 can be ordered into a fiber group, and the ordered fiber group of fibers may be ribbonized. Here, ribboning includes connecting or sealing together the ordered group of fibers to form the ribbon 116e1 that has loose ends at one end and a ribbon fiber extending toward the other end (e.g., toward a first side of external ribbon splice 118). As another example, a ribbon 116e2 can be formed from fibers among the second set of loose fibers 110 and the third set of loose fibers 114 in a first direction (e.g., the upward direction in FIG. 1A). That is, a first group of fibers from among the second set of loose fibers 110 and/or the third set of fibers 114 can be ordered and ribbonized to form ribbon 116e2. Here, ribboning includes connecting or sealing together the ordered group of fibers to form the ribbon 116e2 that has loose ends at one end and a ribbon fiber extending toward the other end (e.g., toward a second side of external ribbon splice 118). As another example, a ribbon 116i1 can be formed from fibers among the second set of loose fibers 110 and the third set of loose fibers 114 in the first direction (e.g., the upward direction in FIG. 1A). That is, a second group of fibers from among the second set of loose fibers 110 and/or the third set of fibers 114 can be ordered and ribbonized to form ribbon 116i1. Here, ribbonizing includes connecting or sealing together the ordered group of fibers to form the ribbon 116i1 that has loose ends at one end and a ribbon fiber extending toward the other end (e.g., to a first side of internal ribbon splice 120). As another example, a ribbon 116i2 can be formed from fibers among the second set of loose fibers 110 and the third set of loose fibers 114 in a second direction (e.g., the downward direction in FIG. 1A). That is, a third group of fibers from among the second set of loose fibers 110 and/or the third set of fibers 114 can be ordered and ribbonized to form ribbon 116i2. Here, ribboning includes connecting or sealing together the ordered group of fibers to form the ribbon 116i2 that has loose ends at one end and a ribbon fiber extending toward the other end (e.g., to a second side of internal ribbon splice 120). In some implementations, the ribbons 116 enable ribbon splicing the device 100, as described herein.

As further shown in FIG. 1A, the optical module 104 may include an external ribbon splice 118 and an internal ribbon splice 120. The external ribbon splice 118 is a ribbon splice connecting ribbon 116e1 and the ribbon 116e2 (e.g., such that light to/from the external components can be coupled from/to components of the optical module 104). The internal ribbon splice 120 is a ribbon splice connecting ribbon 116i1 and the ribbon 116i2 (e.g., such that light to/from components of the optical module 104 can be coupled to other components of the optical module 104). In this way, ribbon splices (e.g., external ribbon splice 118, internal ribbon splice 120) can be used to interconnect ribbons 116 formed from an ordered group of loose fibers. In some implementations, where the external ribbon splice 118 is formed, a ribbon of fibers (e.g., ribbon 116e1) from a first direction may be spliced with a complementary ribbon of fibers (e.g., the ribbon 116e2) from a second (opposite) direction. In some implementations, where the internal ribbon splice 120 is formed, a ribbon of fibers (e.g., the ribbon 116i1) from a first direction may be spliced with a complementary ribbon of fibers (e.g., the ribbon 116i2) from a second (opposite) direction.

As further shown, the optical module may include one or more other components, such as one or more active components 122 and one or more passive components 124. In some implementations, one or more fibers of the one or more active components 122 or one or more fibers from the one or more passive components 124 may be coupled to the fiber routing device 112 or the set of passive components 108.

In some implementations, as illustrated in FIG. 1A, the set of passive components 108 and the fiber routing device 112 may be collocated in the optical module 104. For example, the set of passive components 108 may be arranged in a stack, and the fiber routing device 112 may be arranged on (e.g., on a top surface of) or below (e.g., under a bottom surface of) the set of passive components 108. In some implementations, such an arrangement of the fiber routing device 112 and the set of passive components 108 enables the second set of loose fibers 110 (i.e., the loose fibers of the set of passive components 108) and the third set of loose fibers 114 (i.e., the loose fibers of the fiber routing device 112) to be collocated or commonly aligned in one or more directions (e.g., the upward and downward directions). In some implementations, the fiber routing device 112, and the collocation of the fiber routing device 112 with the set of passive components 108, allows a number of groups of fibers that can be ribbonized and/or a number of fibers in each ribbon 116 to be increased (e.g., as compared to ribbonizing that can be achieved without the use of a fiber routing device). Thus, the fiber routing device 112, and the arrangement of the fiber routing device 112 relatives to the set of passive components 108, increases ribbon splice opportunities, provides greater flexibility in a number of fibers per ribbon splice and per ribbon, and reduces a number of splices of individual fibers required within the device 100.

In some implementations, as shown in FIG. 1A and noted above, the external ribbon splice 118 and the internal ribbon splice 120 may connect ribbons within the optical module 104. For example, the external ribbon splice 118 may connect the ribbon 116e1 with the ribbon 116e2. As another example, the internal ribbon splice 120 may connect the ribbon 116i1 and the ribbon 116i2. In this way, the assembly of the optical module 104 is simplified by reducing a number of splices required (e.g., as compared to using non-ribbonized fibers).

In some implementations, the fiber routing device 112 includes one or more planar structures that hold one or more fiber features. For example, the fiber routing device 112 may include a first planar structure (e.g., a first piece of sheet material, such as a paper material) and a second planar structure (e.g., a second piece of sheet material, such as a paper material) between which the fiber features are routed and held. In another example, the fiber routing device 112 includes a single planar structure (e.g., an adhesive sheet) to which the fiber features are adhered.

In some implementations, the fiber routing device 112 may be collocated with the set of passive components 108 so that the third set of loose fibers 114 (e.g., extending from two sides of the fiber routing device 112) are commonly aligned with the second set of loose fibers 110 to enable ribboning with fibers from among the second set of loose fibers 110 (e.g., extending from two sides of the set of passive components 108). In this way, the fiber routing device 112 allows fibers of the set of passive components 108, fibers of the fiber routing device 112, and/or one or more other fibers in the optical module 104 (e.g., a fiber from an active component 122, a fiber from a passive component 124), or the like, to be collocated and commonly aligned so that the fibers can be arranged in ordered groups and ribbonized, as described above. Notably, by aligning and collocating fibers in the device 100, a number of fiber groups that can be formed may be increased, which reduces a number of splice operations needed during assembly of the optical module 104 (e.g., because each ribbon can be spliced at a ribbon spice instead of each fiber being spliced individually).

As noted above, the fiber routing device 112 may include one or more fiber features associated with organizing fibers for forming groups of fibers (sometimes referred to herein as ribbon groups). Put another way, the one or more fiber features of the fiber routing device 112 are features that facilitate organization of fibers of the device 100 into groups of fibers (e.g., order groups of fibers) that can be ribbonized (to form ribbonized groups of fibers, as described herein). A fiber feature may be, for example, be a loop feature that provides a change of fiber direction, a change feature that provides a change of a fiber type, a termination feature that provides a termination of a fiber, an idle feature that provides management of an idle fiber, or the like. In some implementations, within the fiber routing device 112, a given fiber feature may be routed along a curved path, a curved channel, a straight path, or a straight channel, among other examples.

In some implementations, a given fiber feature is held by a planar structure. For example, the fiber routing device 112 may include single planar structure, and a given fiber feature may be adhered to a surface of the single planar structure. As another example, the fiber routing device 112 may include two planar structures, and a given fiber feature may be arranged between the two planar structures (e.g., such that the given fiber feature is adhered to one or both of the planar structures). Here, a first end of the fiber feature is at a first side of the fiber routing device 112 (e.g., such that a fiber pigtail extends from the first side of the fiber routing device 112), and a second end of the fiber feature may be at a second side of the fiber routing device 112 (e.g., such that a fiber pigtail extends from the second side of the fiber routing device 112). Here, the first side of the fiber routing device 112 may be the same side of the fiber routing device 112 as the second side (e.g., when the fiber feature is a loop feature) or may be a different (e.g., opposite) side of the fiber routing device 112 (e.g., when the fiber feature is a change feature). Alternatively, the first end of the fiber feature may be at the first side of the fiber routing device 112 (e.g., such that a fiber pigtail extends from the first side of the fiber routing device 112), and the second end of the fiber feature be between the first side of the fiber routing device 112 and the second side of the fiber routing device 112 (e.g., when the fiber feature is an idle feature).

In some implementations, the fiber routing device 112 may be structured so that the fiber features of the fiber routing device 112 are held in a particular configuration (and order) at one or more sides of the fiber routing device 112. In some implementations, the particular configuration in which the fiber features are held may be designed based on the specific characteristics of the optical module 104. In some implementations, the fiber routing device 112 may be assembled independently with its fiber features and connections, and the fiber routing device 112 is installed into the optical module 104 in a manner similar to that of other passive components (e.g., the set of passive components 108). In some implementations, the planar nature of the fiber routing device 112 is advantageous for arranging fibers and for placing the fiber routing device 112 on (or below) the set of passive components 108. In some implementations, the optical module 104 may include multiple fiber routing devices 112, and each fiber routing device 112 may include one or more fiber features (e.g., such that the multiple fiber routing devices 112 form a stack of fiber features).

In some implementations, the fiber routing device 112 can be formed by a process including (1) obtaining a first piece of sheet material, one side of which has adhesive; (2) placing fibers as in accordance with a designed fiber trace on the adhesive side of the first piece of sheet material to form fiber features; and (3) placing a second piece of sheet material on top of the fiber trace and adhering to the adhesive side of the first piece of sheet material. In some implementations, the two pieces of a sheet material can retain routed fibers between them through adhesive force between the two pieces of sheet material.

In some implementations, an assembly process for the optical module 104 including the fiber routing device 112 includes a series of operations. A first operation is associated with the placement of components of the optical module 104 and pigtail fiber disposition. Here, the components of the optical module 104 (e.g., the set of passive components 108, the fiber routing device 112, the external ribbon splice 118, the internal ribbon splice 120, the one or more active components 122, the one or more passive components 124, or the like) are placed in pre-defined arrangements or locations according to a design of the optical module 104. Here, the set of passive components 108 and the fiber routing device 112 can be placed such that fibers extending from the set of passive components 108 and the fiber routing device 112 extend in two common but opposite directions (e.g., as illustrated in FIG. 1A). In some implementations, the set of passive components 108 and the fiber routing device 112 can be stacked to facilitate ribboning, as described above. In some implementations, the fibers of the set of passive components 108 and the fiber routing device 112 are placed according to pre-defined groups and orders for each direction (e.g., so that each group can be organized into a ribbon 116 as described herein). Notably, fibers in or near a center of a given ribbon 116 may have reduced splicing loss (e.g., as compared to fibers at or near an edge of the given ribbon 116). Thus, a fiber order in a group of fibers can be considered to optimize splicing loss when ribbonized (e.g., a splicing point with higher sensitivity on splicing loss can be nearer to the center of the given ribbon 116).

A second operation is associated with ribbon fiber splicing and routing. Here, the groups of fibers from one direction can ribbonized to form one or more ribbons 116, and the one or more ribbons 116 can be routed and ribbon spliced at a given ribbon splice (e.g., the external ribbon splice 118 or the internal ribbon splice 120). In some implementations, remaining individual fibers (e.g., fibers not included in a ribbon 116) can be routed and spliced as needed. Notably, the use of ribbons 116 increases flexibility in association with managing or routing (e.g., as compared to single fibers). For example, ribbons 116 may not require a tray (e.g., clippers may be sufficient), and routing can occur such that limitations on PCB/PCBA design are reduced (e.g., as compared to routing individual fibers).

FIG. 1B is a diagram illustrating an example of an assembled optical module 104. As illustrated in FIG. 1B and described above, the fiber routing device 112 is collocated with (e.g., arranged on) the set of passive components 108, which enables ribbonizing of fibers among the set of second loose fibers 110 of the set of passive components 108 and the third set of loose fibers 114 of the fiber routing device 112 before splicing at the external ribbon splice 118 or the internal ribbon splice 120. Notably, FIG. 1B is provided for illustrative purposes—only a few fibers are shown (e.g., numerous fibers and ribbons 116 and are not illustrated in FIG. 1B) and only a single loop feature 202 is shown in the fiber routing device 112.

As indicated above, FIGS. 1A and 1B are as examples. Other examples may differ from what is described with regard to FIGS. 1A and 1B. The number and arrangement of components shown in FIGS. 1A and 1B are provided as examples. In practice, there may be additional components, fewer components, different components, or differently arranged components than those shown in FIGS. 1A and 1B. Furthermore, two or more components shown in FIGS. 1A and 1B may be implemented within a single component, or a single component shown in FIGS. 1A and 1B may be implemented as multiple, distributed components.

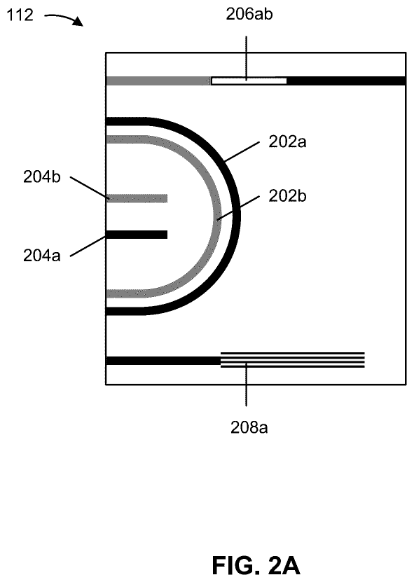

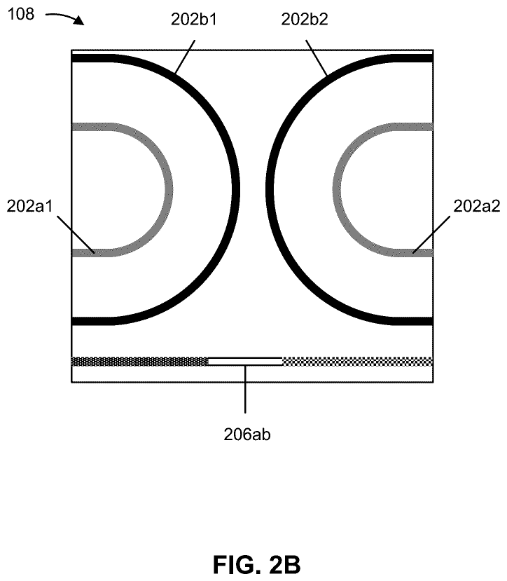

FIGS. 2A and 2B are diagrams illustrating examples of fiber routing devices 112 including various fiber features. In the example shown in FIG. 2A, the fiber routing device 112 includes a first loop feature 202a, a second loop feature 202b, a first idle feature 204a, a second idle feature 204b, a change feature 206ab, and a termination feature 208a.

A loop feature 202 is a feature that provides a change in fiber direction. That is, the loop feature 202 enables light to enter the fiber routing device 112 from a first direction and exit the fiber routing device 112 in the first direction (e.g., such that the light enters and exits the fiber routing device 112 on the same side of the fiber routing device 112). In some implementations, the loop feature 202 may include a semicircular curve (e.g., a 180 degree bend). A loop feature 202 may be formed from a fiber of a particular fiber type, and fiber types may vary among loop features 202 of the fiber routing device 112. For example, as shown in FIG. 2A, the first loop feature 202a is associated with a first fiber type, and the second loop feature 202b is associated with a second fiber type.

An idle feature 204 is a feature that provides management of an idle fiber. An idle fiber may be, for example, a fiber that enables a particular (e.g., standard-sized) ribbon splice to be used. For example, if a ribbon splice of the optical module 104 (e.g., internal ribbon splice 120 or external ribbon splice 118) is designed to receive sets of six fibers, then a given group of fibers of a ribbon 116 could include four active fibers and two idle fibers to complete the set of six fibers for the ribbon splice. Here, a given idle fiber can originate/terminate at an idle feature 204 within the fiber routing device 112. Notably, the use of idle fibers, and total fiber length, do not appreciably increase cost or add loss to the device 100. An idle feature 204 may be formed from a fiber of a particular fiber type, and fiber types may vary among idle features 204 of the fiber routing device 112. For example, as shown in FIG. 2A, the first idle feature 204a is associated with the first fiber type, and the second idle feature 204b is associated with the second fiber type.

A change feature 206 is a feature that provides a change of fiber type. For example, in FIG. 2A, the change feature 206ab provides a change of fiber type between the first type of fiber and the second type of fiber. In some implementations, the change feature 206 includes a splicing point with re-coating between two different fiber types to provide the change of fiber type. In some implementations, the fiber routing device 112 may include multiple change features 206, and types of fibers may vary among on the change features 206.

A termination feature 208 is a feature that provides termination of a fiber. For example, in FIG. 2A, the termination feature 208 provides a termination of a fiber of the first type. In some implementations, the termination feature 208 may be, for example, an angle cleaved terminator (e.g., an 8 degree angle cleaved terminator). In some implementations, the termination feature 208 may include a splice protector, as illustrated in FIG. 2A. Alternatively, the termination feature may in some implementations not include a splice protector. In some implementations, the fiber routing device 112 may include multiple termination features 208, and types of fibers may vary among on the termination features 208.

In the example shown in FIG. 2B, the fiber routing device 112 includes a first loop feature 202a1, a second loop feature 202b1, a third loop feature 202a2, a fourth loop feature 202b2, and a change feature 206ab. Notably, the examples shown in FIGS. 2A and 2B are provided for illustrative purposes, and other configurations or implementations of fiber features within the fiber routing device 112 are possible.

As indicated above, FIGS. 2A and 2B are provided as examples. Other examples may differ from what is described with regard to FIGS. 2A and 2B. The number and arrangement of fiber features shown in FIGS. 2A and 2B are provided as example. In practice, there may be additional fiber features, fewer fiber features, different fiber features, or differently arranged fiber features than those shown in FIGS. 2A and 2B.

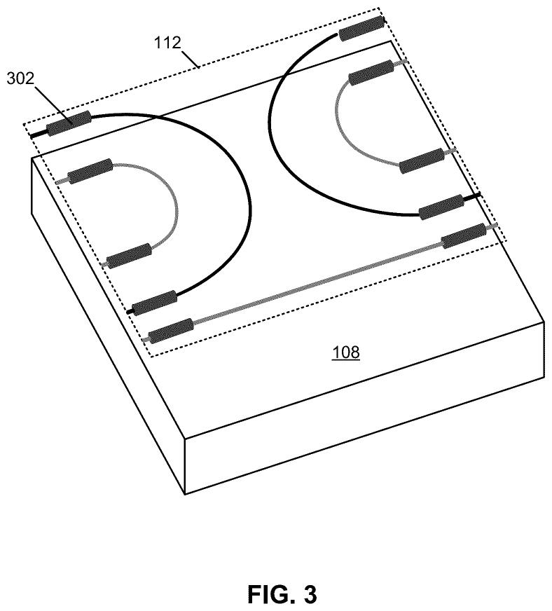

FIG. 3 is a diagram of an example illustrating an example fiber routing device 112 including a set of tube components 302. In some implementations, a tube component 302 may serve to fix an order of fibers in the fiber routing device 112. That is, the tube component 302 may be used to maintain fiber order among fibers of the fiber routing device 112, which further simplifies the ribbon splicing process described herein.

As indicated above, FIG. 3 is provided as an example. Other examples may differ from what is described with regard to FIG. 3.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A fiber routing device, comprising:
a planar structure; and
a set of fiber features associated with organizing fibers for forming ribbon groups, the set of fiber features being held by the planar structure,
wherein a first end of a fiber feature of the set of fiber features is at a first side of the fiber routing device, and a second end of the fiber feature is one of:
at a second side of the fiber routing device, or
between the first side of the fiber routing device and the second side of the fiber routing device.

2. The fiber routing device of claim 1, wherein the first side of the fiber routing device is a same side of the fiber routing device as the second side of the fiber routing device.

3. The fiber routing device of claim 1, wherein the first side of the fiber routing device is an opposite side of the fiber routing device from the second side of the fiber routing device.

4. The fiber routing device of claim 1, wherein the first side of the fiber routing device is a same side of the fiber routing device as the second side of the fiber routing device, and the fiber feature is associated with changing a fiber direction.

5. The fiber routing device of claim 1, wherein the first end of the fiber feature is one fiber type and the second end of the fiber feature is another fiber type, and the fiber feature is associated with changing a fiber type.

6. The fiber routing device of claim 1, wherein the second end of the fiber terminates inside the fiber routing device, and the fiber feature is associated with terminating a fiber.

7. The fiber routing device of claim 1, wherein the second end of the fiber feature starts within the fiber routing device, and the fiber feature is associated with managing an idle fiber.

8. The fiber routing device of claim 1, wherein each fiber feature in the set of fiber features is adhered to the planar structure.

9. The fiber routing device of claim 1, wherein the fiber feature is a first type of fiber feature and another fiber feature of the set of fiber features is a second type of fiber feature.

10. The fiber routing device of claim 10, wherein the first type of fiber feature is a same type of fiber feature as the second type of fiber feature.

11. The fiber routing device of claim 1, wherein the set of fiber features includes a plurality of fiber features, wherein the plurality of of fiber features includes at least two different types of fiber features.

12. The fiber routing device of claim 1, further comprising a first ribbon fiber formed from a first set of loose fibers on the first side of the fiber routing device, wherein each fiber in the first set of loose fibers extends from a respective fiber feature from the set of fiber features.

13. The fiber routing device of claim 12, further comprising a second ribbon fiber formed from a second set of loose fibers on the second side of the fiber routing device, wherein each fiber in the second set of loose fibers extends from a respective fiber feature from the set of fiber features.

14. A device, comprising:
a first set of loose fibers;
a set of passive components having a second set of loose fibers; and
a fiber routing device having a third set of loose fibers,
wherein the fiber routing device and the set of passive components are collocated such that the first set of loose fibers, the second set of loose fibers, and the third set of loose fibers are collocated or aligned in opposite directions.

15. The device of claim 14, wherein an ordered group of fibers from among at least two of the first set of loose fibers, the second set of loose fibers, or the third set of loose fibers forms a ribbon.

16. The device of claim 14, further comprising a ribbon splice interconnecting a first ribbon with a second ribbon to form an internal ribbon splice,
wherein the first ribbon and the second ribbon are formed from groups of fibers from among at least two of the first set of loose fibers, the second set of loose fibers, or the third set of loose fibers.

17. The device of claim 14, further comprising a ribbon splice interconnecting a first ribbon with a second ribbon to form an external ribbon splice,
wherein the first ribbon is formed from a group of fibers from among at least two of the first set of loose fibers, the second set of loose fibers, or the third set of loose fibers, and
wherein the second ribbon is formed from a group of fibers connected to one or more components external to an optical module of the device.

18. An optical card, comprising:
an optical module including:
a fiber routing device including a plurality of fiber features associated with organizing fibers for forming ribbon groups,
wherein a first fiber feature of the plurality of fiber features is a first type of fiber feature and a second fiber feature of the plurality of fiber features is a second type of fiber feature that is different from the first type of fiber feature.

19. The optical card of claim 18, wherein a third fiber feature of the plurality of fiber features is a third type of fiber feature that is different from the first type of fiber feature and the second type of fiber feature.

20. The optical card of claim 19, wherein the first type of fiber feature is a type of fiber feature associated with changing a fiber direction, the second type of fiber feature is a type of fiber feature associated with changing a fiber type, and the third type of fiber feature is a type of fiber feature associated with managing an idle fiber.

21. The optical card of claim 18, wherein a first end of the first fiber feature is at a first side of the fiber routing device, and a second end of the first fiber feature is at a second side of the fiber routing device or is between the first side and the second side.

22. The optical card of claim 18, wherein the fiber routing device comprises a planar structure, and each fiber feature in the plurality of fiber features is adhered to the planar structure.

23. The optical card of claim 18, wherein the optical module further comprises a set of passive components collocated with the fiber routing device such that fibers among a plurality of sets of loose fibers are collocated or aligned in opposite directions.

24. The optical card of claim 23, wherein an ordered group of fibers from among the plurality of sets of loose fibers forms a ribbon.

25. The optical card of claim 23, further comprising a ribbon splice interconnecting a first ribbon with a second ribbon to form an internal ribbon splice,
wherein the first ribbon and the second ribbon are formed from groups of fibers from among the plurality of sets of loose fibers.

26. The optical card of claim 23, further comprising a ribbon splice interconnecting a first ribbon with a second ribbon to form an external ribbon splice,
wherein the first ribbon is formed from a group of fibers from among the plurality of sets of loose fibers, and
wherein the second ribbon is formed from a group of fibers connected to one or more components external to the optical module.

27. The optical card of claim 18, wherein the fiber routing device includes a first planar structure and a second planar structure,
wherein the plurality of fiber features is between the first planar structure and the second planar structure.
